(19) United States
(12) Patent Application Publication
(10) Pub. No.: US 2005/0245148 A1
(43) Pub. Date: Nov. 3, 2005

(54) Swim fins

(76) Inventor: Sang-Hyub Mun, SEOUL (KR)

Correspondence Address: John W Renner;Renner Otto Boisselle & Sklar, 19th Floor, 1621 Euclid Avenue, Cleveland, OH, 44115, US

(21) Appl. No.: 10/523,152

(22) PCT Filed: Jul. 22, 2003
(86) PCT No.: PCT/KR03/01446

§ 371 Date: Jan. 27, 2005

(30) Foreign Application Priority Data
Jul. 29, 2002 (KR) 20-2002-0022701

(51) Int. Cl. H04K 1/00

(52) U.S. Cl. 441/64

(57) ABSTRACT

Disclosed herein are swim fins having a length corresponding to about one and half times of a shoe length thereof. The swim fin comprises a silicone rubber shoe (1) and a hooked short plastic fin panel (2), which are formed by compression molding. In order to prevent a flow of water passing over the swim fin from being rapidly dispersed laterally, the fin panel (2) of the swim fin is bent downwardly by an angle of 45 to form a hooked end portion. The hooked end portion of the fin panel (2) is blocked at both sides thereof, and formed with an air/water circulation slot (7) at the respective blocked sides. Such a swim fin can increase a transmission effect of kicking motion energy when it draws water and push the drawn water backward. Especially, the swim fin generates a buoyancy propulsive force during butterfly stroke, thereby enabling the swimmer's body to easily rise to the water's surface.

### TECHNICAL FIELD

The present invention relates to swim fins, and more particularly to swim fins for high-speed swimming. A fin panel of the swim fin not having a long length corresponding to about two times of a shoe length, but having a short length projecting from the shoe about half the shoe length, thereby having a length corresponding to about a quarter of a fin panel length of the conventional products, a fin panel of the swim fin being configured in such a fashion that its front end portion is bent downwardly by an angle of about 45° to form a hooked portion, and blocked at both sides thereof, the hooked front end portion of the fin panel being formed with an air/water circulating slot at the respective blocked sides thereof.

### BACKGROUND ART

In general, conventional foreign made single-type swim fins comprise a swim kick panel, which is formed to have an elongated flat shape having no hooked portion. Due to such an elongated flat shape, the conventional swim fins have a disadvantage in that a flow of water passing over the upper surface of the swim kick panel is too rapidly dispersed laterally and slipped away therefrom, and in that the configuration of the swim kick panel is unsuitable for reducing a resistance to the flow of water, thereby inducing a decreased propelling or driving force incapable of sufficiently pushing water backward as the swimmer passes through the water. This increases the number and difficulty of the swimmer's kicking motions, and thus exerts significant stress on the lower part of the leg and ankle portion of the swimmer, resulting in painful muscle fatigue.

### DISCLOSURE OF THE INVENTION

Therefore, the present invention has been made in view of the above problems, and it is an object of the present invention to provide swim fins, which allow people to easily learn and pleasantly enjoy swimming, resulting in an increase in popularity of swimming and an explosion of the swimming population. Further, the present invention is provided for promoting national health, and restricting import of foreign products.

In accordance with the present invention, the above and other objects can be accomplished by the provision of a swim fin comprising: a plastic fin panel having a short length corresponding to about half of a shoe length, the fin panel comprising a hooked end portion bent downwardly by an angle of 45°, and blocked at both sides thereof, the hooked end portion being formed with an air/water circulation slot at the respective blocked sides thereof.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a top plan view illustrating a swim fin of the present invention;

FIG. 2 is a side view of the swim fin according to the present invention;

FIG. 3 is a bottom view of the swim fin according to the present invention;

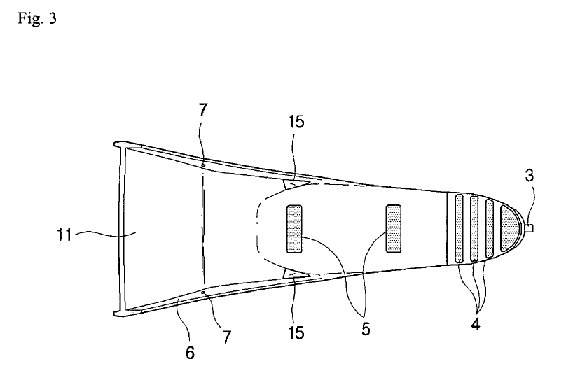

FIG. 4 is a sectional view taken along a line A-A′ shown in FIG. 1; and

FIG. 5 is a real picture of the swim fin according to the present invention.

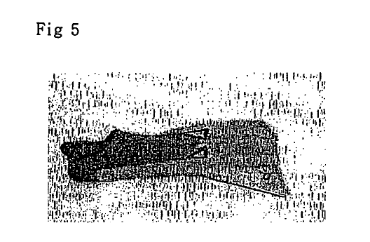

### BEST MODE FOR CARRYING OUT THE INVENTION

Now, a coupling relation between respective components of a swim fin according to the present invention will be explained in detail, with reference to the accompanying drawings.

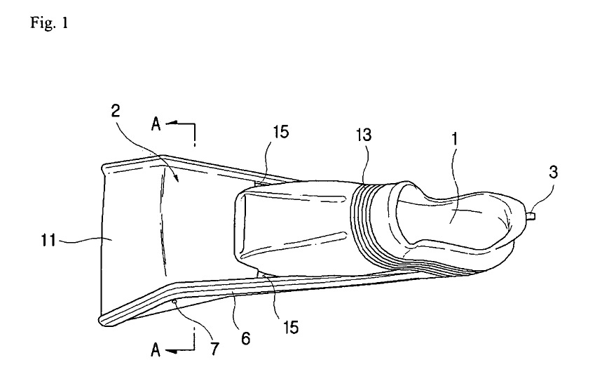

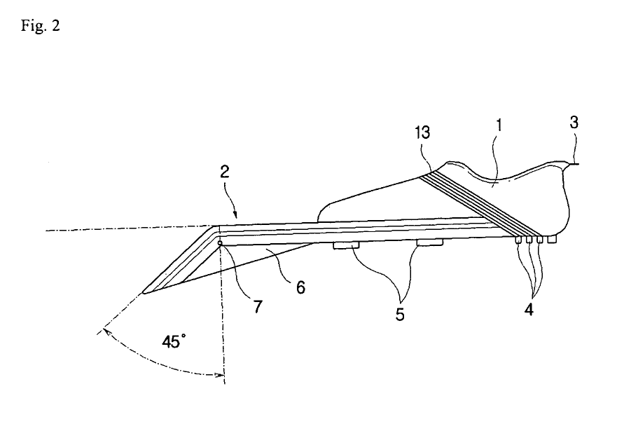

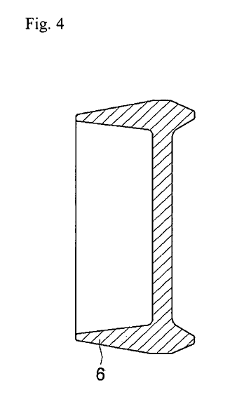

Referring to FIGS. 1 and 2, the swim fin of the present invention comprises a silicone made rubber shoe 1, and a plastic fin panel 2, which are integrally formed using a compression molding method. The plastic fin panel 2 has a relatively short length when compared with conventional products, and is bent downwardly by an angle of about 45° at the front-end portion thereof to form a hooked end portion. Generally, an angle between the leg and the ankle of the swimmer on swimming is about 45°, so the angle of about 45° is formed at the front-end portion in order that the fin panel parallels with surface of water. Referring to FIG. 4 as a sectional view of the swim fin, the swim fin further comprises a deflection-limiting unit 6, which serves to prevent the hooked plastic fin panel 2 from being deflected or distorted due to a resistance to the flow of water.

As stated above, the plastic fin panel 2 of the swim fin is bent downwardly at the front end portion 11 thereof to form the hooked end portion 11, in consideration of its reflection action according to the resistance to the flow of water generated when the swimmer kicks water with both his/her feet using the swim fins. In order to effectively prevent the hooked end portion 11 of the plastic fin panel 2 from being bent or distorted left ward and rightward, the deflection-limiting unit 6 is organically and operatively coupled to the hooked plastic fin panel 2. That is, the hooked end portion of the plastic fin panel 2 is blocked at both sides thereof by the deflection-limiting unit 6, and the deflection-limiting unit 6 is formed with an air/water circulation slot 7 at the respective sides thereof blocking the both sides of the plastic fin panel 2. Furthermore, the plastic fin panel 2 is formed with two holes 15 penetrating through the surface from top to bottom at a rear end portion thereof, thereby reducing the resistance to the flow of water when the swimmer kicks. By virtue of the deflection limiting unit 6, it is possible to prevent the flow of water passing over the hooked plastic fin panel 2 from being too rapidly dispersed laterally due to the fast kicking motions of the swimmer, thereby transmitting momentum of the swimmer's kicking motions to the swim fins with maximum efficiency while effectively aiding in the forward travel of the swimmer.

The hooked plastic fin panel 2 comprises an upper swim kick surface operating as a shovel, and a lower swim kick surface operating as a buoyancy propulsive member. During backstroke, the upper swim kick surface of the hooked plastic fm panel 2 serves to backwardly push the flow of water passing theretrough as the swimmer kicks water with the top of the swimmer's foot During free stroke, breast stroke and butterfly stroke, the lower swim kick surface of the hooked plastic fin panel 2 serves to draw water toward the hooked plastic fin panel 2, and then push the drawn water backward. The air/water circulation slots 7, formed at the both sides of the deflection-limiting element 6 downstream of the hooked end portion of the plastic fin panel 2, form small-diameter air/water circulation passages. These air/water circulation slots 7 serve to allow air and water captured inside the deflection limiting unit 6 connected to the hooked end portion of the plastic fin panel 2 to be rapidly extracted out of the swim fin when the swim fin rises to the water's surface.

As shown in FIG. 2, the silicone made rubber shoe 1 of the swim fin is patterned with three embossed lines 13 extending from the top of the rubber shoe 1 to the bottom sole thereof These three embossed lines 13 function as elastic bands for causing the swimmer's foot to be tightly held in place in the rubber shoe 1 of the swim fin as if the swimmer were to tighten the rubber shoe 1 with rubber strings. The three embossed lines are connected, respectively, with slippage prevention protrusions 4 provided at the bottom sole of the rubber shoe 1 for preventing the slippage of the swim fin when the user walks on the water's bottom surface, diving platforms, or anywhere around a swimming environment Each of the slippage prevention protrusions 4 has the same line shape as the respective embossed lines 13. In addition to the slippage prevention protrusions 4, the bottom sole of the rubber shoe 1 is provided with embossed slippage prevention rubber plates 5. In consideration of the fact that the hooked end portion 11 of the plastic fin panel 2 is bent downwardly as stated above, the heights of the slippage prevention protrusions 4 and embossed slippage prevention rubber plates 5 are adjustable in conforming to the bottom level of the hooked end portion 11 to have a certain inclination. The rubber shoe 1 is additionally provided with a loop 3 at the upper rear edge thereof in order to aid the swimmer in easily putting on the rubber shoe 1 by gripping the loop 3 with his/her fingers.

In case of the swim fin according to the present invention, the swim fin is configured in such a fashion that the length of the plastic fin panel 2 corresponds to about half of the length of the rubber shoe 1 and the front end portion of the plastic fin panel 2 is bent downwardly by an angle of about 45° to form the hooked end portion 11. As the plastic fin panel 2 is configured as stated above, the swimmer's leg can maintain a horizontal relation with the fin panel 2, thereby minimizing its resistance to the flow of water and maximizing a propelling force thereof.

As stated above, the hooked plastic fin panel 2 of the swim fin functions as the buoyancy propulsive member capable of pushing a large amount of water backward. This utilizes the same principle as when the swimmer pushes water backward with both his/her palms of the gathered hands. In addition, in order to solve the rapid flow and dispersion problem of the water passing over the swim fin, as stated above, the plastic fin panel 2 of the present invention is bent downwardly at the front end portion 11 thereof to form the hooked end portion, and the hooked end portion 11 is blocked at the both side thereof and formed with the air/water circulation slot 7 at the respective blocked sides. This configuration of the hooked plastic fin panel 2 is ideal for improving a transmission effect of kicking motion energy when the swimmer draws the water and then kicks the drawn water backward.

During butterfly stroke, especially, the hooked swim fin generates a high speed buoyancy propulsive force for causing the upper body of the swimmer to easily rise to the water surface as the swim fin effectively draws water, and pushes the drawn water downwardly and backwardly.

### Industrial Applicability

As apparent from the above description, the present invention provides a swim fin functioning as if the swimmer were to push water backward with both his/her palms of the gathered hands as the swimmer passes through the water, thereby causing the body of the swimmer to move forward. In addition, the swim fin of the present invention utilizes a principle in that birds fly up from water by kicking the water surface. The swim fin of the present invention comprises a rubber shoe and a plastic fin panel. The fin panel of the swim fin has a projecting length corresponding to about a half of the length of the rubber shoe thereof As the length of the swim fin is short, it is possible to prevent any excessive force from being applied to the ankle portion of the swimmer even if the swimmer excessively swims for a long time, and to improve the efficiency of kicking motions while reducing a required force for the kicking motions. Further, according to the present invention, the swim fin is bent downwardly at the front end portion thereof by an angle of 45° to form a hooked end portion, and the swim fin is adapted to generate a buoyancy propulsive force capable of drawing water and strongly pushing the drawn water backward, thereby enabling the swimmer to easily and rapidly move forward.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A swim fin comprising:
a plastic fin panel having a length corresponding to about half of a shoe length, the fin panel comprising a hooked end portion bent downwardly by an angle 45° and deflection limiting units integrally formed at both sides thereof, and the respective deflection limiting unit being formed with an air/water circulation slot at the respective sides thereof.

2. The swim fin as claimed in claim 1, wherein the fin panel is formed with at least one hole penetrating through the surface from top to bottom at a rear end portion thereof.

3. The swim fin as claimed in claim 1, wherein the shoe of the swim fin is Patterned with a plurality of embossed lines extending from the top of the shoe to the bottom sole thereof.

4. The swim fin as claimed in claim 1, wherein the bottom sole of the shoe is provided with embossed protrusions and rubber plates for slippage prevention.
